(19) United States
(12) Patent Application Publication
(10) Pub. No.: US 2010/0181211 A1
(43) Pub. Date: Jul. 22, 2010

(54) ELECTROCHEMICAL SENSOR AND BIOSENSOR AND METHOD OF ELECTROCHEMICAL MEASUREMENT

(76) Inventors: Jan Krejci, Predklasteri (CZ); Zuzana Grosmanova, Brno (CZ); Jan Krejci ML., Predklasteri (CZ); Denisa Maderankova, Opatovice (CZ); Tomas Marvanek, Tisnov (CZ); Roman Havlik, Tisnov (CZ)

Correspondence Address: NOTARO, MICHALOS & ZACCARIA P.C., 100 DUTCH HILL ROAD, ORANGEBURG, NY, 10962, US

(21) Appl. No.: 12/595,885

(22) PCT Filed: Apr. 23, 2008
(86) PCT No.: PCT/CZ2008/000048

§ 371 Date: Oct. 14, 2009

(30) Foreign Application Priority Data
Apr. 27, 2007 (CZ) PV 2007-309

(51) Int. Cl. G01N 27/28; G01N 27/26

(52) U.S. Cl. 205/792; 204/400; 204/403.01; 205/775

(57) ABSTRACT

The invention relates to an electrochemical sensor or biosensor that contains a substrate which bears at least one working electrode and a heating element, optionally also a temperature measuring element. This electrochemical sensor or biosensor allows to achieve better mass transport towards the working electrode during the measurement process. The invention further relates to a method of electrochemical measurement using the sensor or biosensor of the invention.

### TECHNICAL FIELD

The invention relates to electrochemical sensors and biosensors with improved mass transfer towards the working electrode.

### BACKGROUND ART

Electrochemical sensors are devices that serve for conversion of physical non-electrical quantity to output measured quantity of electrical physical essence. They contain a working electrode, a reference electrode and eventually also an auxiliary electrode. A sensor modified by a biological substance (e.g. enzyme, antibody, DNA sequence, part of plant or animal tissue, etc.), is called a biosensor.

At present, sensors and biosensors are being intensively developed and that causes an effort to protect different technical solutions and production technologies. Active sensor and biosensor layer preparation method—sputtering—is known (U.S. Pat. No. 6,805,780). Another possibility is the preparation of active and protective layers of the sensor or biosensor by screen printing (U.S. Pat. No. 6,004,441). Solution using an array of biosensors was also published (US 2005247559), which enables simultaneous measurement of more analytes. Another patented procedure combines the previous methods to the intent that the active layer is applied first and its final dimension is acquired by laser ablation (U.S. Pat. No. 7,073,246). The sensor or biosensor active layer is built on the base material in all the above-described cases. The sensor or biosensor response is often influenced by interfering substances. These substances can preferably be removed by a filtration component integrated on the sensor. Such a solution is described in U.S. Pat. No. 7,198,708. There is a frequent need to measure very small sample quantities. The exact contact of sample and active sensor/biosensor area has to be defined in such cases. It can be done by integration of a channel, in which the working electrode of the sensor is placed (U.S. Pat. No. 6,503,381). New technological procedures can be used for the preparation of channels or sampling capillaries, as described in U.S. Pat. No. 6,787,013 and in CZ 297082. Results of measurements using these sensors are provided for example in publication: B. P. Schaffar, Thick film biosensors for metabolites in undiluted whole blood and plasma symplex, Journal of Analytical and Bioanalytical Chemistry 372 (2002), 254-260. Common limitation of the above mentioned solutions is the fact that the analyte transport to the working electrode is controlled by diffusion, which is a relatively slow process.

The key problem in electrochemical sensors and biosensors is the transport of the electroactive substance from the volume of working solution to the working electrode. The transport consists of two components: transport driven by hydrodynamics and transport driven by diffusion. The substance is transported to the electrode mainly by hydrodynamics, i.e. flow, up to certain distance only. A boundary layer is present in the vicinity of the electrode due to liquid viscosity, wherein the mass transport is controlled by diffusion only. Diffusion is a relatively slow process. Diffusion in the boundary Nernst layer is a critical parameter for most electrochemical processes; it controls the electrode response rate. The reproducibility and transport in the vicinity of the electrode can be enhanced by improving the hydrodynamic transport of substance to the electrode in a defined manner. Many solutions were published, the most widely known being the rotation disc electrode (V. G. Levich, “Physicochemical Hydrodynamics”, Prentice-Hall, Euglewood Cliffs, N.J., 1962). Homogenous flow that causes mass transport is generated by disc rotation; the electrode is placed on the disc surface. If the flow dependence on the rotation speed of the disc is observed, diffusion processes can be omitted by extrapolation in the limiting case. Wall jet is an alternative embodiment where liquid sprays on the electrode surface (K. \check{S}tulik, V. Pacáková: Electroanalytical measurements in flowing liquids, SNTL, 1989). Another known embodiment is thin layer—liquid flows in a narrow slot, one wall of which is formed by the electrode and the second one is from an inert material or both walls are formed by electroactive material. Many other embodiments were described, e.g. rotating wire, ring disc rotating electrode and many others. There are many citations on the topic in the scientific literature. However, there is a consequential limitation of the process that is caused by electrode character and liquid viscosity. If the flow intensity or electrode rotation in case of rotation disc electrode is increased, at certain circumstances the Reynolds number is sufficiently high to change laminar flow in the vicinity of the electrode to turbulent flow. Fluctuations, whirls occur at certain point, then break away and substantially change the mass transport caused by the flow to electrode. It is mainly manifested by formation of very strong fluctuations of the measured signal. A limit is defined by the transition of laminar flow to turbulent flow. The limit should not be overcome with regard to optimisation of mass transfer to the electrode by induced convection. Another important fact is that the electrochemical reaction occurring on the electrode surface itself is chiefly influenced by mass transfer in the 10 nm thick layer. This layer cannot be stirred by hydrodynamic flow induced by external pressure difference. The boundary layer thickness is in order of 100 μm (i.e. 4 orders more than the layer in which the reaction occurs) at liquid movement speed of approx 1 m/s (this is high speed compared to velocities usually applied in sensor field) and at flowing along a planar area. Sliding velocity for the case of flow in a channel with characteristic height of 1 mm is 10⁻⁵ m/s (at the boundary of the layer in the distance of 10 nm from the electrode surface), i.e. 5 orders lower speed than the liquid flow velocity in the middle of the channel. It is apparent that the layer where the electrochemical reaction occurs cannot be influenced by hydrodynamics in fact and the mass transfer is controlled by diffusion.

Use of temperature gradient in conjunction with electrochemical reaction is known. It is, however, exclusively used for thermoelectrochemical fuel elements (T. I. Quickenden, Y. Mua: The power conversion efficiencies of thermogalvanic cell operated in three different orientations, J. Electrochem. Soc., 142, Issue 11, 3652-3659, 1995; B. A. Bilal, H. Tributsch: Thermo-electrochemical reduction of sulphate to sulphide using and graphite cathode, Journal of Applied Electrochemistry, Vol. 28, No. 10, 2004) or for measurement of thermodynamic systems characteristics (S. H. Oh, C. B. Bahn, I. S. Hwang: Evaluation of Thermal Liquid Junction Potential of Water-Filled External Ag/AgCI Reference Electrodes, J. Electrochem. Soc., 150, Issue 6, E321-E328, 2003; S. H. Oh, C. B. Bahn, W. I. Cho, I. S. Hwang: Theoretical Analysis of the Electrode Potential of the Newly Designed KCl Buffered External Ag/AgCl Electrode, J. Electrochem. Soc., 151, Issue 11, E327-E334, 2004; V. N. Sokolov, L. P. Safonova, A. A. Pribochenko: The Thermal Diffusion of Hydrogen Chloride in Water-Monoatomic Alcohol Mixtures at 298 K, Journal of Solution Chemistry, 35, issue 12, 1621-1630, 2006; V. N. Sokolov, V. A. Kobenin: Electrochemical determination of standard thermal diffusion characteristics for chlorides of hydrogen and potassium in water-ethanol solutions, Russian Journal of Electrochemistry, Vol. 42, No. 9, 938-942, 2006; V. N. Sokolov, A. A. Pribochenko, L. P. Safonova: Entropy characteristic of solvation and thermal diffusion of hydrogen chloride in water-1-propanol solutions: and thermoelectrochemical determination, Russian Journal of Electrochemistry, Vol. 42, No. 9, 969-973, 2006; V. N. Sokolov, L. P. Safonova, A. A. Pribochenko: The thermal diffusion of hydrogen chloride in aqueous solutions of acetonitrile, Russian Journal of Physical Chemistry, Vol. 80, No. 9, 1433-1437, 2006; V. N. Sokolov, V. A. Kobenin, N. A. Litova: The thermal diffusion characteristics of hydrogen and alkali metal chlorides in aqueous-methanolic solutions at 298.15 K, Russian Journal of Physical Chemistry, Vol. 80, No. 4, 2006). These systems consist of a thermoelectrical cell, wherein one electrode and the adjacent solution are kept at temperature T₁; and the second electrode and the adjacent solution are kept at temperature T₂. Temperature gradient is created between two different solutions in these systems.

The disadvantages of current solutions of mass transport towards the working electrode are solved by the present invention.

### DISCLOSURE OF INVENTION

Object of the present invention is an electrochemical sensor or biosensor, which contains a substrate that is provided with at least one working electrode and a heating element.

It is an aspect of the invention that the substrate is further provided with a temperature measuring element.

It is another aspect of the invention that the substrate is from 0.01 mm to 5 mm thick.

It is an aspect of the invention that the substrate material has the coefficient of temperature conductivity higher than 1.10⁻⁶ m²s⁻¹. Preferably, the substrate is made of material selected from the group comprising corundum, corundum ceramics, beryllium ceramics, glass and plastic material with high temperature conductivity. Suitable plastic material with high temperature conductivity is for example Teflon filled with carbon fibres.

In a preferred embodiment, the electrochemical sensor or biosensor according to the present invention is placed on the Peltier element, which enables cooling of the sensor.

In one preferred embodiment of the electrochemical sensor or biosensor according to the present invention, the heating element is placed on the opposite side of the substrate than the working electrode, preferably, if desired, the heating element can be separated from the surrounding solution by a dielectric layer.

It is a further aspect of this preferred embodiment that the substrate is provided with a temperature measuring element, which is placed on the same side of the substrate as the heating element.

Preferably, the electrochemical sensor or biosensor substrate is provided with at least two working electrodes and the opposite side of the substrate against the electrodes is provided with a common heating element. Preferably, a temperature measuring element is placed by the common heating element.

Preferably, the electrochemical sensor or biosensor substrate can be provided with at least two working electrodes and the opposite side of the substrate against each electrode is provided with an independent heating element with its own feeding; it enables independent temperature regulation of each working electrode. Preferably, one temperature measuring element is placed by each heating element.

In another preferred embodiment of the electrochemical sensor or biosensor according to the present invention, the heating element is placed inside the substrate. The substrate can be then provided with a temperature measuring element placed inside the sensor substrate.

Preferably, the electrochemical sensor or biosensor substrate can be provided with at least two working electrodes and a common heating element is placed inside the substrate. A temperature measuring element is preferably placed by the common heating element inside the substrate.

Preferably, the electrochemical sensor or biosensor substrate is provided with at least two working electrodes and an independent heating element with its own feeding is placed under each electrode inside the substrate. The heating elements enable independent temperature regulation of each electrode. One temperature measuring element is preferably placed by each heating element inside the substrate.

In yet another preferred embodiment of the electrochemical sensor or biosensor of the present invention, the heating element is placed between the substrate and the working electrode and is separated from the working electrode by a dielectric layer. Preferably, the substrate is further provided with a temperature measuring element, which is placed between the substrate and the working electrode and is separated from the working electrode by a dielectric layer.

Preferably, the electrochemical sensor or biosensor substrate is provided with at least two working electrodes and a common heating element is placed between the substrate and the working electrodes. Preferably, a temperature measuring element is placed by the common heating element between the substrate and the working electrodes.

Preferably, the electrochemical sensor or biosensor substrate is provided with at least two working electrodes and an independent heating element with its own feeding is placed between each working electrode and the substrate, enabling independent temperature regulation of each electrode, whereas the heating element is separated from the working electrode by dielectric layer. One temperature measuring element is preferably placed by each heating element between the substrate and the working electrode and is separated from the working electrode by a dielectric layer.

Another object of the invention is a method of electrochemical measurement using an electrochemical sensor or biosensor, wherein the working electrode of the electrochemical sensor or biosensor according to the present invention is contacted with the measured solution, the working electrode of the electrochemical sensor or biosensor according to the present invention is then brought to a temperature other than the temperature of the measured solution and the temperature of the working electrode is kept different from the temperature of the measured solution during the measurement.

In a preferred embodiment, the temperature of the working electrode is periodically changed with frequency from 0.01 Hz to 1 kHz during the measurement.

The invention solves the problem of mass transport towards the working electrode in a new way, which consists in a new embodiment, wherein the working electrode is formed for example on a thin corundum substrate or on a thin substrate made of corundum ceramics or on a thin substrate made of beryllium ceramics or on a thin substrate made of glass or on a thin substrate made of plastic material with high temperature conductivity. A heating element is placed on the opposite side of the substrate. The system is placed into a solution and the electrode is heated by the heating to a temperature that is different from the temperature of the liquid in which the measurement is performed. This system where the liquid temperature is different from the working electrode temperature is characterized by the fact that, apart from diffusion, thermodiffusion and microconvection in the vicinity of the electrode are participating in the mass transport. Corundum ceramics, corundum, beryllium ceramics, glass, eventually plastic material with high temperature conductivity are characterized by the fact that they possess a much higher temperature conductivity coefficient than liquids. As the substrate is thin, it has much higher temperature conductivity than the liquid; and as the heating element is directly integrated on the substrate, the substrate is uniformly heated even in the presence of the liquid of a different temperature.

The temperature conductivity coefficient of the liquid is several orders higher than the diffusion coefficient of the same liquid. Both coefficients are expressed in the same units and they are dimensionally comparable from the point of view of creating boundary layers. Therefore, it is possible to reach a very high temperature gradient in the boundary layer adjacent to the working electrode. It means that thermodiffusion as a mass transport driving power is comparable with motive power of diffusion (concentration gradient). Similarly, microconvection caused by local temperature gradient will play an important role in mass transport, this role is comparable with mass transport induced by diffusion only. This phenomenon is fully concentrated in the boundary layer and it disappears in the area of prevailing convection. It is a completely opposite situation in comparison with convection; i.e. mixing and mass transport depending on the temperature gradient are concentrated in the boundary layer and there is no limitation similar to the limitation for the forced convective transport, in relation to the Reynolds number. In other words: the more intensively the liquid is mixed, the bigger the temperature gradient is in the liquid layer adjacent to the electrode and the more intensive is the mass transfer caused by microconvection and thermodiffusion.

The invention is further illustrated by the following examples which should not be construed as further limiting.

### FIGURES

FIG. 1 shows a schematic view of the measurement according to Example 1

FIG. 2 shows the effect of the temperature difference on the sensor response at cyclic voltammetry measurement.

FIG. 3 displays the embodiment of the active sensor area for the measurement according to Example 2.

FIG. 4 shows a schematic view of the measurement according to Example 2.

FIG. 5 shows the scheme of a device for electrochemical and biosensoric measurements with inserted sensor according to Example 3.

FIG. 6 displays a schematic embodiment of the sensor according to Example 5.

FIG. 7 shows a schematic view of the device according to Example 6.

FIG. 8 shows a schematic view of the embodiment according to Example 7.

FIG. 9 shows a schematic view of the device according to Example 8.

FIG. 10 shows a schematic view of the device according to Example 9.

FIG. 11 shows a schematic view of the device according to Example 10.

FIG. 12 shows a schematic view of the device according to Example 11.

FIG. 13 shows a schematic view of the device according to Example 12.

### EXAMPLES

### Example 1

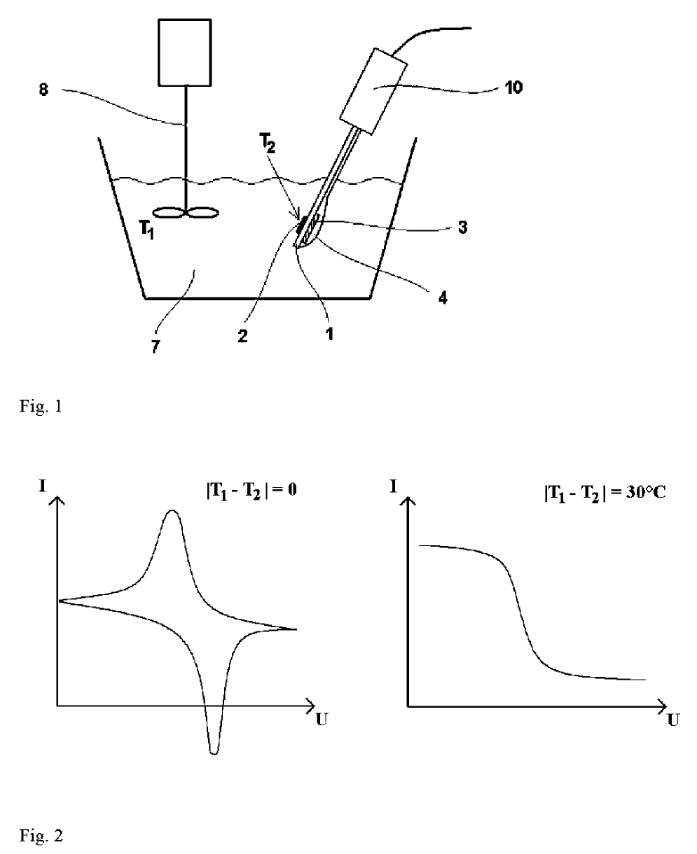

Schematic embodiment of the measurement is shown in FIG. 1. The electrochemical sensor or biosensor created by placing a working electrode 2 onto a thin ceramic substrate 1 provided from the opposite side of the substrate 1 with a heating element 3, which is covered by a dielectric layer 4, is placed in a connector 10, that is properly fixed in a classical electrochemical vessel 7, which is mildly mixed by a stirrer 8. The vessel is kept at a constant temperature T₁ and the sensor or biosensor is kept at a constant temperature T₂. The temperature T₂, being the temperature of the sensor or biosensor, is generated by the heating element 3 that is placed on the sensor rear side. The substrate 1, on which the sensor or biosensor is formed, is made of corundum ceramics or beryllium ceramics 0.1-1 mm thick. The working electrode 2 has the same temperature as the substrate due to the high temperature conductivity of the substrate material. The working electrode, which is 2-20 μm thick, is tightly connected to the ceramic substrate. The device is shown in FIG. 1.

The effect of the temperature gradient is shown in FIG. 2. The response with no temperature gradient is classical cyclic voltammetry, which is difficult to interpret. The complicated record is changed by the temperature difference application to an easy relation that is easy to interpret and it can be used to a simple determination of half wave potential, which is characteristic for a given substance. Therefore, the method facilitates very much the composition analysis of the tested substance.

### Example 2

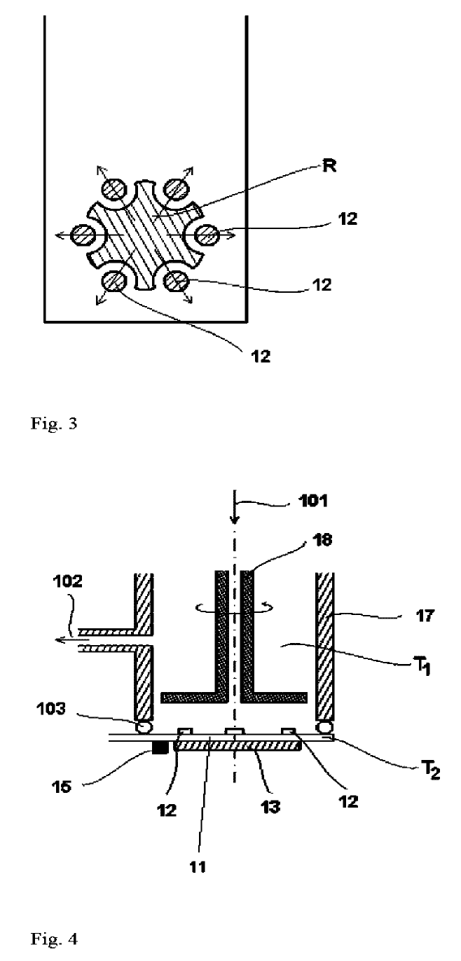

An array of working electrodes (2-200) 12 and a reference electrode R is prepared on a corundum substrate 11 or on a substrate 11 made of corundum or beryllium ceramics (FIG. 3).

The sensor or biosensor is placed in a measuring vessel 17, so that the substrate 11 forms its bottom. Tightness is secured by an o-ring 103. A stirring element 18 is placed above the array of working electrodes 12. The analyzed solution enters through the stirrer hollow central part 101 towards the electrode array. The liquid is uniformly spread between individual working electrodes 12 by the stirring element 18 rotation and it leaves through exit 102. Both the measuring vessel 17 and the entering liquid are kept at a constant temperature T₁. The sensor or biosensor is kept at a constant temperature T₂ by heating 13, which is placed on the opposite side of the substrate 11 against the working electrodes 12. With regard to the fact that the substrate 11 material, on which the sensor or biosensor is prepared, has much higher temperature conductivity than the liquid that is washing it, the whole sensor or biosensor is uniformly heated and it is possible to use an integrated thermometer 15 for the sensor or biosensor temperature determination and to control the difference between T₁ (temperature of the liquid) and T₂ (sensor or biosensor temperature). The system enables simultaneous measurements on a number of electrodes.

### Example 3

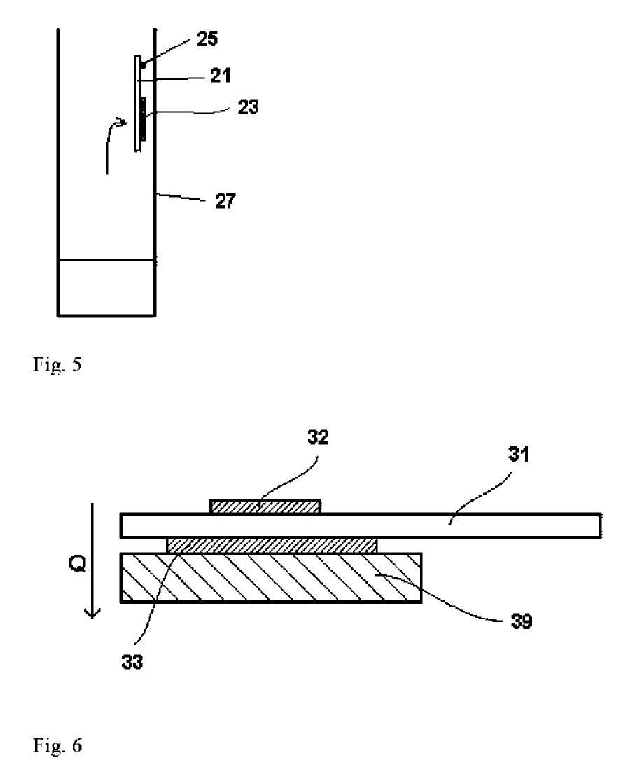

The device according to the patent CZ 287676/2001 “Device for electrochemical and biosensoric measurements performance” (see FIG. 5), wherein a sensor or biosensor with substrate 21 is placed, the substrate bearing a heating 23 on the rear side, that enables to keep the sensor or biosensor at a different temperature than the temperature of the liquid in the vessel 27. A temperature sensing element 25 can be integrated on the rear side of the sensor or biosensor.

### Example 4

The thermodiffusion coefficient can have different values. In most cases, a substance is transported from the area with higher temperature to the area with lower temperature. This phenomenon can be used with advantage for construction of a biosensor with immobilised substances that are thermally unstable. In this case, the liquid is kept at higher temperature than the temperature of the sensor; and the sensor is cooled by Peltier element to a temperature, which is substantially lower than the sample temperature. Two phenomena thus occur. Diffusion processes proceed much faster because the sample is heated and also composition unhomogenities get balanced faster as all these processes depend on temperature. As the sensor itself has a lower temperature, the analytes enter due to thermodiffusion to the vicinity of the electrode. The electrode has a lower temperature, which blocks the degradation of bioactive substances that are placed on the electrode surface. This arrangement can be with advantage used mainly in Example 2 and Example 3.

### Example 5

A device (FIG. 6) uses the fact that the sensor or biosensor substrate 31 materials have very high temperature conductivity and they can be prepared very thin. In this case, the device is constructed in the following manner: on the surface of Peltier element 39, a sensor or biosensor containing a working electrode 32, a substrate 31 and a heating 33 is fastened. The Peltier element 39 cools the sensor or biosensor containing the working electrode 32, the substrate 31 and the heating 33. The heating 33 can interrupt the heat removal flow and supply heat into the system. The temperature inertia of the system is very small due to the sensor, eventually biosensor substrate 31 thickness being in the range of from 0.1 to 2 mm and due to the fact that the heating itself is 20 μm thick. It enables to reach the temperature pulsation frequency of up to 1 kHz. Relaxation phenomena occur due to this pulsation; it enables reaction kinetics analysis on the electrode surface. By temperature pulses frequency change it can be determined from how deep part of the monitored system the information is obtained. The depth is very approximately proportional to the square root of the temperature conductivity coefficient of the material used for the bioactive layer construction. The device is schematically shown in FIG. 6. Onto the sensor, eventually biosensor substrate 31, made of corundum ceramics or beryllium ceramics, a working electrode 32 is applied. On the rear side of the sensor substrate 31, heating 33 is applied, under which the Peltier element 39 is placed that cools the sensor and causes the heat flow Q.

### Example 6

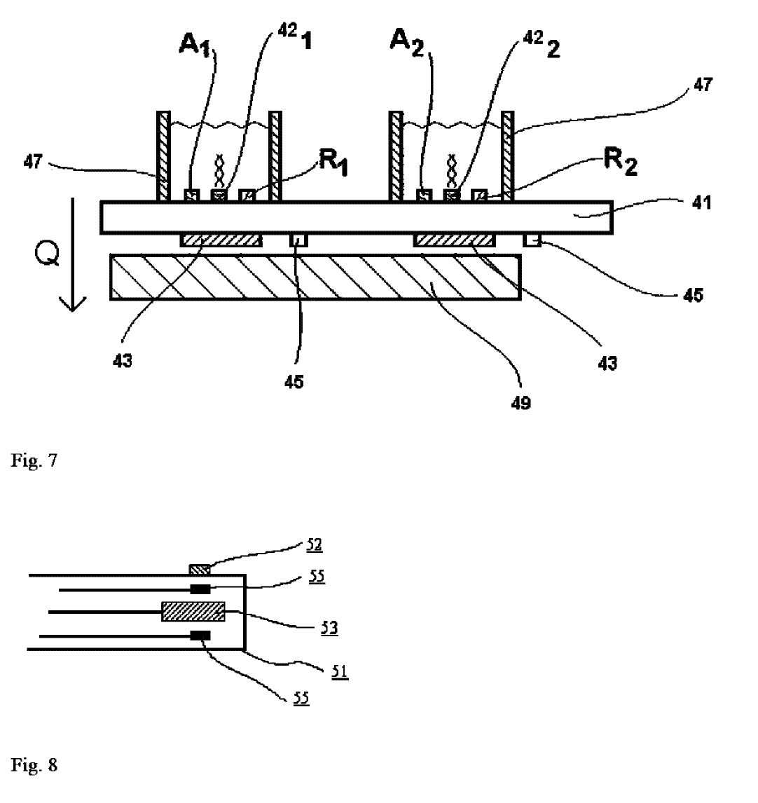

The device according to the invention can be with advantage used for the construction of DNA biosensor with direct hybridization. The device (FIG. 7) consists of Peltier element 49, on which is integrated a biosensor consisting of substrate 41 made of corundum ceramics, on which is the temperature sensing element 45, biosensor working electrodes 42₁, 42₂, . . . , 42ₙ, reference electrodes R₁, R₂, . . . , Rₙ and auxiliary electrodes A₁, A₂, . . . , Aₙ and a heating 43. The active side of the sensor is equipped with microvessels 47, so that in the bottom of each microvessel is placed one working, one reference and one auxiliary electrode. Under each vessel there is placed the heating element 43 and the control thermometer 45. The system forms an array, and if proper chemicals are put into the vessels 47, it is possible to periodically change temperature from −20 to +60 degrees Centigrade. The DNA amplification can be performed by the system. It allows to measure a proper DNA segment without any modifications of the final amplified solution. DNA adsorption on the working electrode can be achieved in a suitable embodiment and subsequently, adsorbed DNA amount can be detected. The device for simple electrochemical determination of DNA characteristics is thus created, i.e. a simple DNA chip.

The device substantially accelerates the amplification, mainly due to the temperature control being performed by affecting the heat flow Q by the sensor integrated heating. The invention thus solves the long heat persistence of the system, which is the disadvantage of e.g. the device according to the patent EP1591543 (DNA amplification). The temperature gradient causes mass transfer to the vicinity of the detecting electrodes and microconvective mixing of samples.

### Example 7

A substrate 51 (FIG. 8), on which a structure of active electrodes 52 is created, is constructed so that a heating element 53 is placed inside the substrate body. The heating element can be placed into the ceramic substrate body using LTCC (Low Temperature Cofired Ceramics), HTCC (High Temperature Cofired Ceramics) technologies or by inserting the heating element between two plates from beryllium or corundum ceramics which are connected by ceramic or glass solder. In case of LTCC or HTCC technologies, the resulting material contains a high aliquot part of Al₂O₃ and its temperature conductivity is high. The heating element can be with advantage created by thermistor paste printing on crude ceramics layer using LTCC and HTCC technologies.

For the integration of the temperature sensor into the substrate body can be used the same method as for the heating element. Its position can be between the heating element 53 and the working electrode 52 or on the external part of the heating element or in both mentioned positions.

Integration of the temperature measuring element into the sensor substrate body enables more uniform sensor heating and also higher measurement accuracy. When the heating 53 and the temperature measurement sensor 55 are inside the substrate 51 then the whole sensor is more robust and more chemically resistive.

### Example 8

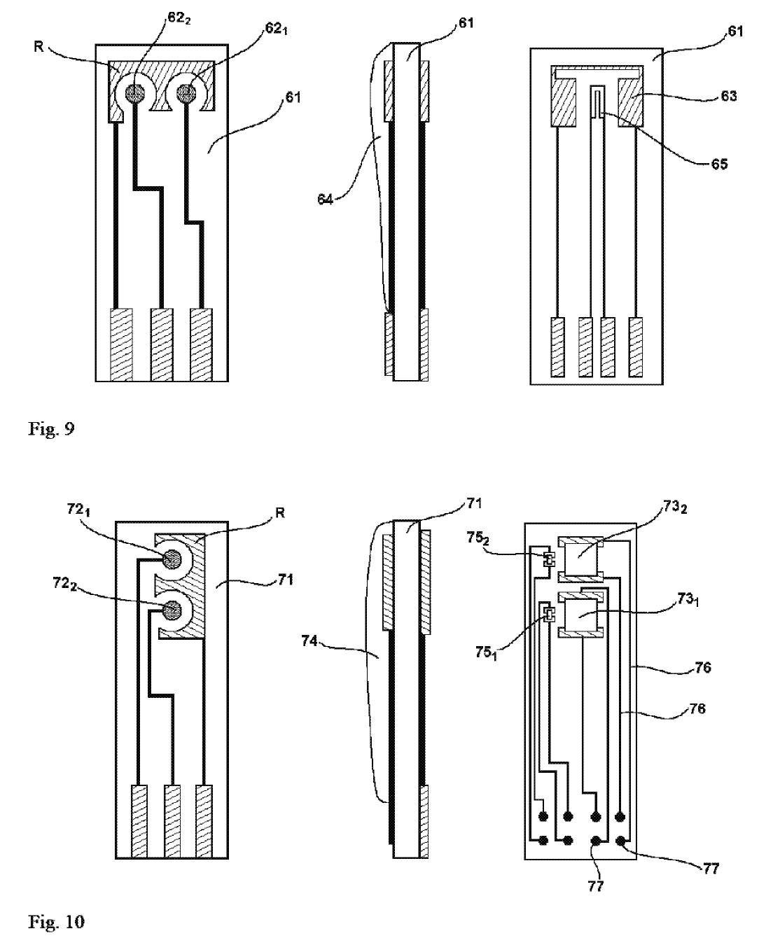

The substrate 61 (FIG. 9), made of corundum, corundum ceramics or beryllium ceramics is equipped on one side with two working electrodes 62 and a common reference electrode R. From the other side, the substrate is equipped by one heating element 63 and an element 65 for temperature measurement. The heating element and the element for temperature measurement are protected by a dielectric material layer 64.

The embodiment according to the example improves the temperature array distribution in the vicinity of the working electrodes and thus it improves the function of the whole device.

### Example 9

Two working electrodes 72₁ and 72₂ and a reference electrode R are printed on a substrate 71 (FIG. 10) prepared from corundum or beryllium ceramics. Two heating elements 73₁ and 73₂ two elements for temperature measurement 75₁ and 75₂ are placed on the opposite side of the substrate. Both the heating elements and the elements for temperature measurement are connected with output contacts 77 by conducting paths 76. A protective dielectric layer 74 is applied so that it protects the heating elements and the elements for temperature measurement from the contact with external environment, however, it does not overlay the contacts 77, which are used for connection of both heating elements and elements for temperature measurement to an external device. The dielectric layer 74 can be screen-printed with advantage.

The device according to the example enables independent measurements of thermoelectrochemical phenomena on both electrodes.

### Example 10

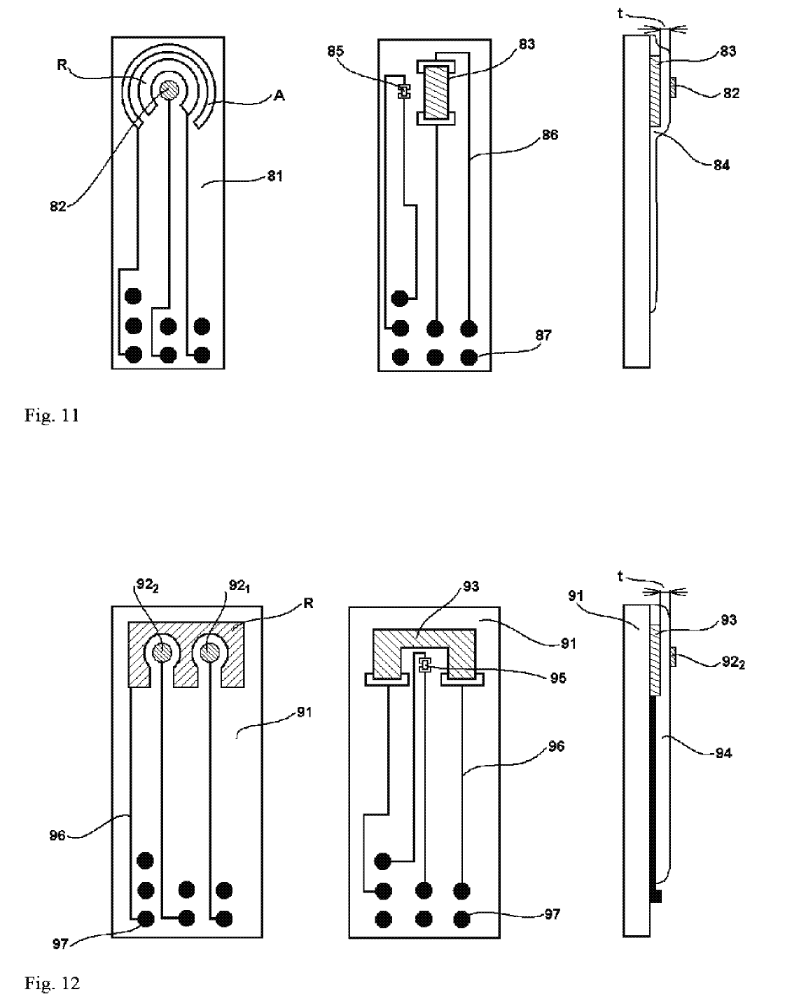

Thermistor paste layer that creates working resistance of a heating element 83, and a layer of thermistor paste that creates an element for temperature measurement 85 are printed on a substrate 81 (FIG. 11) prepared from corundum or beryllium ceramics. Both elements are connected by conducting paths 86 with a contact array 87. The basic structure that ensures sensor heating and temperature measurement is overlaid with a dielectric layer 84. Both layers can be screen-printed.

The next layer are electrochemically active electrodes (working 82, reference R and auxiliary A).

The device according to the example has the significant advantage that the dielectrics thickness between the heating and the working electrode is t=1-10 μm. Very fast temperature changes with the frequency of up to 1 kHz can be achieved if a combination of cooling (see Example 5) and heating integrated on the sensor is used, the heating interrupting the heat flow drawn by the Peltier element. The device enables exciting the relaxing phenomena in biochemical objects, thereby enabling their identification.

### Example 11

On a substrate 91 (FIG. 12) made of corundum ceramics or beryllium ceramics is created a layer of material, which constitutes the working resistance of a heating element 93 and a temperature sensing element. The heating element 93 can be preferably prepared for example by sputtering of Pt. The temperature sensing element can be prepared by sputtering of Pt and its final characteristics are adjusted by laser trimming.

The heating and the temperature measuring elements are covered by a dielectric layer 94 made of Al₂O₃ or BeO that can preferably be prepared by sputtering the materials. Two working electrodes 92₁ and 92₂ and a reference electrode R are applied on the dielectric layer. The working electrodes can be created by Pt sputtering and the reference electrode can be prepared by printing of the active material containing Ag/AgCl.

The device according to the example enables very fast temperature changes due to the dielectric layer thickness t=0.1-1 μm. It enables a simultaneous study of relaxation phenomena on two electrodes. For instance one electrode can be modified by an enzyme and the second electrode by an inert protein. Elimination of interfering phenomena is possible as both processes occur under the same conditions and the relaxation phenomena connected with enzyme kinetics can be obtained with better precision.

### Example 12

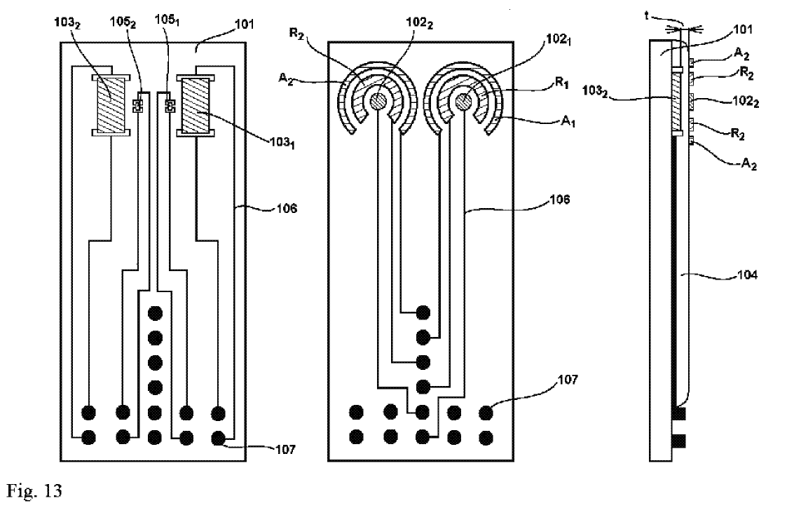

Structure of two heating elements 103₁ and 103₂ and two temperature measuring elements 105₁ and 105₂ is created on a substrate 101 (FIG. 13) made of corundum ceramics or beryllium ceramics. The elements are connected by conducting paths 106 with a contact array 107. The structure is preferably prepared by vapour deposition of conductive material, which is subsequently modified by photolithography. The structure of the heating elements (103₁ and 103₂) and the temperature measuring elements (105₁ and 105₂) is covered by a dielectric layer 104, for example SiO₂ of the thickness t=0.1=5 μm. The dielectric layer 104 is applied so that lands are not covered. Two working electrodes 102₁ and 102₂, two reference electrodes R₁ and R₂ and two auxiliary electrodes A₁ and A₂, which are connected by conductive paths 106 with contact array 107, are applied on the dielectric layer.

The embodiment according to the example enables independent control of thermoelectric processes on each electrode independently. It is possible to change periodically the temperature on each electrode with different frequency. These methods enable the analysis of immobilised layer characteristics, eventually observing other thermoelectrochemical phenomena.

### INDUSTRIAL APPLICABILITY

The electrochemical sensor or biosensor according to the present invention allows to achieve a better mass transport to the working electrode of the sensor or biosensor. It is suitable for use for example in chemical, food-processing and medical industry etc.

1. An electrochemical sensor or biosensor, characterized in that it contains a substrate that is provided with at least one working electrode and a heating element.

2. The electrochemical sensor or biosensor according to claim 1, characterized in that the substrate is further provided with a temperature measuring element.

3. The electrochemical sensor or biosensor according to claim 1, characterized in that the substrate is from 0.01 mm to 5 mm thick.

4. The electrochemical sensor or biosensor according to claim 1, characterized in that the substrate is made of a material having the coefficient of temperature conductivity higher than 1.10⁻⁶m²s⁻¹.

5. The electrochemical sensor or biosensor according to claim 4, characterized in that the substrate is made of a material selected from the group comprising corundum, corundum ceramics, beryllium ceramics, glass and plastic material with high temperature conductivity.

6. The electrochemical sensor or biosensor according to claim 1, characterized in that it is placed on a Peltier element.

7. The electrochemical sensor or biosensor according to claim 1, characterized in that the heating element is placed on the opposite side of the substrate than the working electrode.

8. The electrochemical sensor or biosensor according to claim 7, characterized in that the heating element is separated from the surrounding solution by a dielectric layer.

9. The electrochemical sensor or biosensor according to claim 7, characterized in that the substrate is provided with a temperature measuring element which is placed on the same side of the substrate as the heating element.

10. The electrochemical sensor or biosensor according to claim 7, characterized in that the substrate is provided with at least two working electrodes and the opposite side of the substrate is provided with a common heating element.

11. The electrochemical sensor or biosensor according to claim 10, characterized in that the temperature measuring element is placed by the common heating element.

12. The electrochemical sensor or biosensor according to claim 7, characterized in that the substrate is provided with at least two working electrodes and the opposite side of the substrate against each electrode is provided with an independent heating element with its own feeding, which enables independent temperature regulation of each working electrode.

13. The electrochemical sensor or biosensor according to claim 12, characterized in that one temperature measuring element is placed by each heating element.

14. The electrochemical sensor or biosensor according to claim 1, characterized in that the heating element is placed inside the substrate.

15. The electrochemical sensor or biosensor according to claim 14, characterized in that the substrate is provided with the temperature measuring element placed inside the sensor substrate.

16. The electrochemical sensor or biosensor according to claim 14, characterized in that the substrate is provided with at least two working electrodes and a common heating element is placed inside the substrate.

17. The electrochemical sensor or biosensor according to claim 16, characterized in that the temperature measuring element is placed by the common heating element inside the substrate.

18. The electrochemical sensor or biosensor according to claim 14, characterized in that the substrate is provided with at least two working electrodes and an independent heating element with its own feeding is placed under each working electrode inside the substrate, thereby enabling independent temperature regulation of each working electrode.

19. The electrochemical sensor or biosensor according to claim 18, characterized in that one temperature measuring element is placed by each heating element inside the substrate.

20. The electrochemical sensor or biosensor according to claim 1, characterized in that the heating element is placed between the substrate and the working electrode and is separated from the working electrode by a dielectric layer.

21. The electrochemical sensor or biosensor according to claim 20, characterized in that the substrate is provided with a temperature measuring element, which is placed between the substrate and the working electrode and is separated from the working electrode by a dielectric layer.

22. The electrochemical sensor or biosensor according to claim 20, characterized in that the substrate is provided with at least two working electrodes and a common heating element is placed between the substrate and the working electrodes, the heating element being separated from the working electrodes by a dielectric layer.

23. The electrochemical sensor or biosensor according to claim 22, characterized in that a temperature measuring element is placed by the common heating element between the substrate and the working electrodes, the temperature measuring element being separated from the working electrodes by a dielectric layer.

24. The electrochemical sensor or biosensor according to claim 20, characterized in that the substrate is provided with at least two working electrodes and an independent heating element with its own feeding is placed between each working electrode and the substrate, thereby enabling independent temperature regulation of each electrode, whereas each heating element is separated from the working electrode by a dielectric layer.

25. The electrochemical sensor or biosensor according to claim 24, characterized in that one temperature measuring element is placed by each heating element between the substrate and the working electrode and is separated from the working electrode by a dielectric layer.

26. A method of electrochemical measurement using the electrochemical sensor or biosensor, characterized in that the working electrode of the electrochemical sensor or biosensor according to claim 1 is contacted with the measured solution, the working electrode of the electrochemical sensor or biosensor is then brought to a temperature different from the temperature of the measured solution and the temperature of the working electrode is kept different from the temperature of the measured solution during the measurement process.

27. The method of electrochemical measurement according to claim 26, characterized in that the temperature of the working electrode is periodically changed with frequency of from 0.01 Hz to 1 kHz during the measurement process.
